(19) United States
(12) Patent Application Publication
(10) Pub. No.: US 2019/0254334 A1
(43) Pub. Date: Aug. 22, 2019

(54) Method for Making a Cold-Formed Food Product With a Solid Binder

(71) Applicant: Tropicana Products, Inc., Bradenton, FL (US)

(72) Inventors: Kathryn HOOVER, Chicago, IL (US); Maria Cristabel RAMOS-TIRADO, Algonquin, IL (US)

(21) Appl. No.: 15/902,393

(22) Filed: Feb. 22, 2018

(51) Int. Cl. A23P 10/28; A23L 7/126; A23L 19/00; A23L 25/00; A23L 29/212; A23G 1/50; A23J 7/00

(52) U.S. Cl. CPC A23P 10/28; A23L 7/126; A23L 19/05; A23L 25/00; A23L 29/212; A23V 2250/6406; A23J 7/00; A23V 2002/00; A23V 2200/21; A23V 2250/1842; A23V 2250/5062; A23G 1/50

(57) ABSTRACT

A method for creating a cold formed bar such as a fruit and vegetable bar. The invention is an improved process for manipulating the total sugars without having the cold formed bar lose its characteristic texture or appearance. In one aspect, the invention adds a solid binder to a conventional mixing operation after the liquid binder and the dry ingredients are added. In one aspect, the invention uses a combination binder that allows reduction of liquid binder and reduces added sugar level on finished product. The combination binder does not impact whole piece appearance in the cold form bar while providing enough binding capacity to hold the bar together throughout processing and shelf life.

### BACKGROUND OF THE INVENTION

### 1. Technical Field

The present invention relates to the composition and process of preparing cold-formed fruit and vegetable bars and more particularly to a method of preparing cold-formed bars with a combination of a solid binder and a liquid binder.

### 2. Description of Related Art

Cold-formed bars are a well-known product in the food industry. Cold-formed bars typically are comprised of fruits and vegetables, binder syrup and optionally inclusions, a term in the art for pieces of fruit, nuts, or chocolate. Binder syrup is made of an aqueous solution of simple sugars such as corn syrup, glucose, or fructose. Typical binders contribute to added sugars on a cold form bar with whole inclusions, and binders that do not contribute to added sugar (contain naturally occurring sugars) impact the appearance of a bar and are used in extrusion technology or homogenously blended cold form bars. A spotlight has been cast on added sugars in food systems and the desire for alternative options to sugars has become more pronounced. In snacks and convenience foods, taste is one of the primary drivers for consumption. Simply removing sugar without a replacement is not always an option. For certain applications, sugar-based ingredients provide sweetness, flavor and also functionality. In many snack foods, sugars are used to bind and coat food particles together in a cohesive matrix. Granola, snack bars, fruit and vegetable cold-formed bars are examples. Thus, achieving the same functionalities like sugar is as important as achieving a nice sweetness and flavor in a sugar reduced formula. Naturally occurring sugars are found naturally in foods such as fruit (fructose) and milk (lactose). Added sugars include any sugars that are added to foods or beverages during processing or preparation. Liquid binders contribute to added sugars. However, reducing the amount of liquid binder makes the bar fall apart and does not provide the binding ability. Fruit paste is used for extruded products but not generally for cold-formed bars.

A typical cold-formed fruit and vegetable bar comprises dry ingredients and a liquid binder. An example of a specific formulation is shown in Table 1. In this application, all percentages are by weight unless otherwise specified.

TABLE 1
Ingredients for a Prior Art Cold-Formed Bar

| Ingredient | Formula wt. % |
|---|---|
| Dry Ingredients | 70-75 |
| Liquid Binder | 25-30 |
| Total = | 100.0 |

The process to create cold-formed bars is relatively straightforward and is shown in FIG. 1. The ingredients 10 are serially added to a continuous mixer 15. The dry ingredients are added first, the binder syrup is added second. The inclusions are added last because they may be susceptible to melting from the relatively hot binder syrup. Also, the inclusions are more susceptible to mechanical breakdown and should receive as little processing time as possible.

The mixture at this stage is between ambient temperature (typically 70° F.), and the temperature of the binder syrup (about 130° F.). Manufacturers typically use a continuous flow interrupted flight or paddle mixer for production because it mixes the ingredients in the shortest amount of time, transfers the least amount of energy to the ingredients, and causes relatively little mechanical breakdown.

The mixture at this point is transferred onto a slabbing conveyor 20 where the mixture is compressed with compression rollers 25 to a desired thickness, typically one-half inch. A typical slabbing conveyor is about three feet in width. The mixture is partially cooled 35 as it is rolled out. The slab is sliced 50 and then cut into rectangular bars with a guillotine cutter 60. Each granola bar at this point is about three and one-half inches in length, one to one and one-half inches wide, and weighs between 28 and 35 grams. The bars are cooled 70 to ambient temperature, about 70° F., and packaged 80.

The amount of added sugars primarily due to the liquid binder in a typical fruit and vegetable bar is 4 g per 100 g of the bar. There is a need to reduce the amount of added sugars in the cold-formed bar with other binders such as solid binders. Further, a need exists for an apparatus and method to create a cold-formed food bar that does not lose the integrity or appearance after addition of a solid binder. Furthermore, a need exists for a method of adding a solid binder while maintaining the traditionally expected texture, appearance and flavor. Finally, there is a need to add a solid binder at a desired temperature of the blender and a processing step without causing smearing of the solid binder in the finished food bar.

### SUMMARY OF THE INVENTION

The proposed invention comprises a novel process to generate a cold-formed food bar with a solid binder that reduces the amount of added sugar. The present invention comprises the steps of first making a cold-formable mixture and then forming the mixture into a cold-formed food bar. The invention discloses the embodiments to achieve this objective.

In one embodiment, the cold-formable bar is made with the following steps:

(a) setting a blender to a desired temperature;

(b) adding solid ingredients and mixing the solid ingredients;

(c) adding a liquid binder and mixing the liquid binder;

(d) adding a solid binder forming a cold-formable mixture; and

(e) forming the cold-formable mixture into a food bar.

In an alternative embodiment, the cold-formable bar comprises at least 70% by weight of minimally processed inclusions; at least 20% by weight of a liquid binder; and at least 5% by weight of a solid binder.

In one embodiment, the cold-formed food bar of the present invention has an appearance and texture substantially similar to cold-formed food bar produced by prior art methods with the traditional and expected texture, appearance and flavor of cold-formed food bar.

The above as well as additional features and advantages of the present invention will become apparent in the following written description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart of the typical prior art process for forming a cold-formed food product;

FIG. 2 is a manufacturing system illustrating the process for a cold-formed food bar pursuant to one embodiment of the present invention;

FIG. 3 is a flow chart showing the process for a cold-formed food bar pursuant to one embodiment of the present invention;

FIG. 4 is a perspective view of a resultant cold-formed food bar formed in accordance with one embodiment of the present invention.

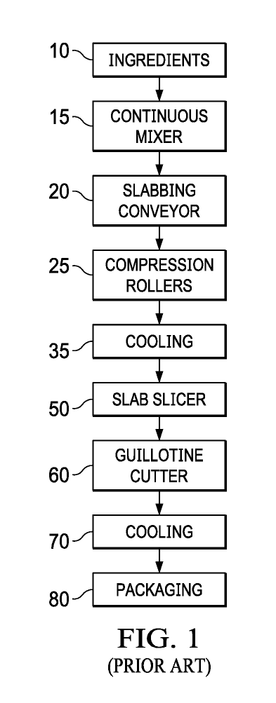

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention. The terms “cold-formed food bar”, “cold-formed bar”, “food bar” are interchangeably used herein to describe a food bar that is stored refrigerated and consumed at refrigerated temperatures or ambient temperatures. The terms “dry ingredients”, “solid ingredients”, “minimally processed inclusions” and “particulates” are interchangeably used herein to indicate ingredients such as dry fruits, dried vegetables, nuts and other inclusions that are substantially in their natural state and that do not undergo substantial processing.

### DETAILED DESCRIPTION

The present invention now will be described more fully hereinafter, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Unless otherwise defined, all terms of art, notations and other scientific terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. The techniques and procedures described or referenced herein are generally well understood and commonly employed using conventional methodology by those skilled in the art, such as, for example, the widely utilized in food industries.

In accordance with the present invention, there is provided a combination binder that allows the binding of food components with dates along with a liquid binder. Since this combination binder is a combination of a liquid binder and solid binder, it can be advantageously used in the production of savory foods with less added sugars.

As used herein, the term “binder” is intended to mean a substance that produces or promotes cohesion in loosely assembled ingredients. Because the binder described herein is intended to be used in the production of food, it is preferably a food-grade binder. In an embodiment, the binder described herein is diced dates.

According to an embodiment, increasing the level of dates and adding after blending cycle, provides enough cohesiveness, softness at refrigerated temperature, and softness for consumption. Added sugars are reduced as dates contain natural sugars and may not contribute to added sugars. According to an embodiment, whole minimally processed inclusions that comprise nuts, dried fruits and dried vegetables may be held together by a combination binder comprising a liquid binder (brown rice syrup, tapioca solids, liquid chicory root extract, glycerin, oil, and lecithin) and a solid binder through the use of dates. This combination binder allows reduction of liquid binder that reduces added sugar level on finished product and does not impact whole piece appearance in the cold form bar while at the same time providing enough binding capacity to hold the bar together throughout processing and shelf-life.

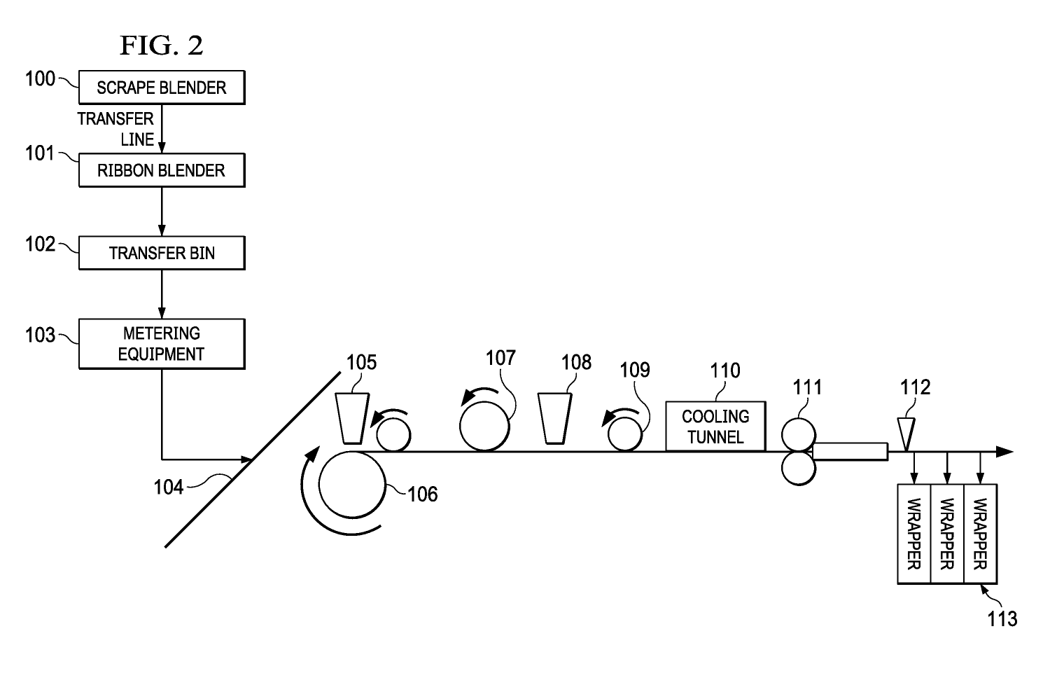

FIG. 2 illustrates an exemplary manufacturing system for manufacturing a cold-formed bar. A scrape bender 100 may be used in series with a ribbon blender or a conical mixer to blend and mix the ingredients. The solid ingredients or dry ingredients are serially added to a continuous mixer or a ribbon blender 101. Dry ingredients such as powdered, crisp, particulate, nuts, cereals, grains, dried vegetable, dried fruit pieces, flavoring compound may then added into the blender. The dry ingredients, flavoring/coloring compounds and mineral and vitamins can also be added together or independently depending on the known art, type of equipment used to manufacture. A gentle mixing of dry ingredients with the binder preserve the integrity of the finished product. The dry ingredients are added first, the binder syrup is added second and the solid binder added last. Also, the solid binder may be more susceptible to mechanical breakdown and should receive as little processing time as possible.

The mixture at this stage is between 120-125° F. and the temperature of the binder syrup (about150° F.). The mixed dough material (“herein referred to as cold-formed mixture or cold-formed dough) may then be fed to a transfer bin 102 and emptied onto the feed conveyor 103. The cold-formed mixture may then be conveyed through a feed conveyor 104 into a hopper 105 in which initial steps directed to formation of the cold-formed product into a conveniently handled form takes place. The mixture may then be fed into a temperature controlled feed rollers 106. According to a preferred exemplary embodiment, the temperature of the feed rollers may be maintained in a range from 100° F. to 130° F. According to another preferred exemplary embodiment, the temperature of the feed rollers may be maintained in a range from 110° F. to 120° F. A cooled compression roll 107 may be employed and the gaps set sequentially such that controlled compression may be applied in order to preselect whether the resulting product will be light and airy texture or denser product, and to minimize breakage of the fragile baked inclusions, yet still provide sufficient pressure to form a slab.

The temperature of product emerging from the compression rolls has started to cool to begin setting the slab, temperature between 80° F. to 90° F. The target dough piece weight may also be selected. Based on this target dough piece weight, the dough throughput rate may be calculated. Brittle ingredients 108 such as kale, blueberries, spinach may be optionally added to the slab and compressed with a compression roll 109 again gently. The brittle ingredients may be kept intact with the solid binder such as dates. The mixture may be sent to a cooling tunnel 110 maintained at less than 50° F. After moving through slitter knives 111 or a forming roll, the rows/ropes may be introduced onto a separating conveyor so that the rows/ropes may be separated with minimal product deformation. A guillotine 112 may be used to cut the ropes to a predetermined length. The guillotine, when cutting product to proper length, will typically use a single stroke and at the end of the stroke move in the direction of product travel slightly to provide product separation. In this embodiment, the cold-formed bar is about 3 to about 3.5 inches in length, about 1½ inches wide, and about ½ inches to about ¾ inches tall and weighs between 37 to 43 grams. These ranges are provided for purposes of illustration and not limitation.

The next step in the process is to cool the cut product to a temperature that will allow the product to set. Finally the product may be collected and transported to a packaging area 113. The food bars may refrigerated for storage and consumption.

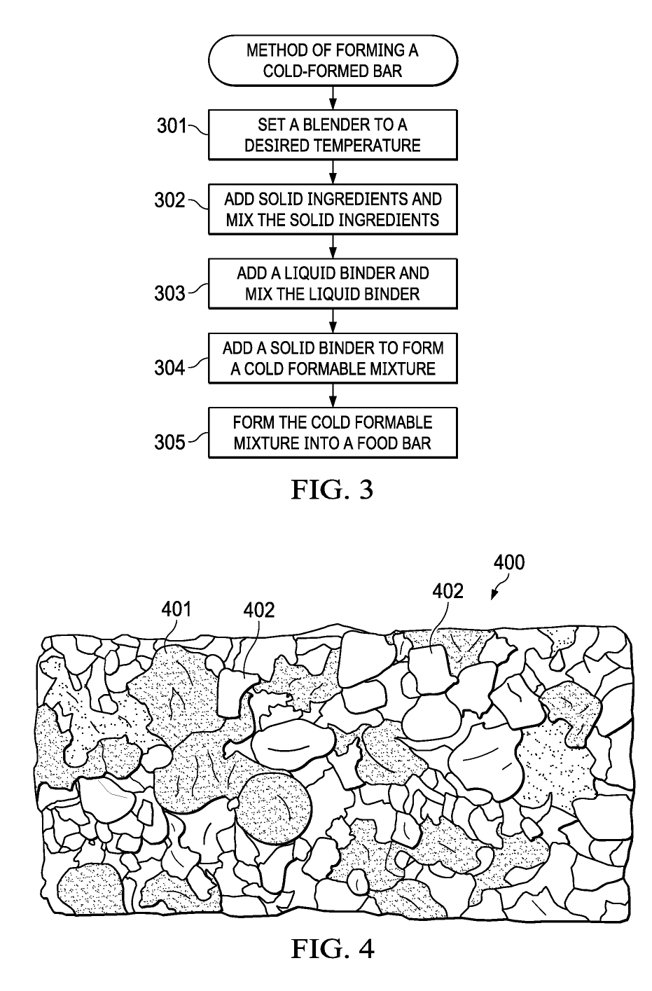

FIG. 3 generally illustrates a method of forming a cold-formed bar according to one preferred embodiment. The instant invention discloses one embodiment whereby the solid binder is added and gently mixed after the addition of solid ingredients and liquid binder. Finally, the instant invention provides a method for economically making large quantities of a cold-formed bar whereby the bars maintain its traditional and expected texture, appearance and flavor. The method comprises the steps of:

1. setting a blender to a desired temperature (301);

It is important that the desired temperature in the blending process is optimized so that the addition of dates at a later step in the process provides adequate binding capacity and cohesiveness to the food bar without smearing. According to a preferred exemplary embodiment the desired temperature in the blender in step (301) ranges from 100° F.-125° F. According to a more preferred exemplary embodiment the desired temperature in the blender in step (301) ranges from 110° F.-140° F. According to another preferred exemplary embodiment the desired temperature in the blender in step (301) ranges from 120° F.-130° F. According to a most preferred exemplary embodiment, the desired temperature in the blender in step (301) is 125° F.

2. adding solid ingredients and mixing the solid ingredients (302);

According to a preferred exemplary embodiment, the solid ingredients are selected from a group consisting of: grains, legumes, fruits, nuts, chocolate chips, vegetables, minimally processed inclusions and combinations thereof. According to another preferred exemplary embodiment mixing in step (302) is performed for a time ranging from 60 seconds to 80 seconds. According to yet another preferred exemplary embodiment mixing in step (302) is performed for a time ranging from 65 seconds to 75 seconds.

3. adding a liquid binder and mixing the liquid binder (303);

According to a most preferred exemplary embodiment mixing in step (303) is performed for a time of 90 seconds. According to a most preferred exemplary embodiment mixing in step (303) is performed for a time ranging from 60 seconds to 90 seconds. According to a most preferred exemplary embodiment mixing in step (303) is performed for a time ranging from 70 seconds to 100 seconds. According to a preferred exemplary embodiment mixing in step (303) is performed at a temperature ranging from 140° F. to 160° F. According to a more preferred exemplary embodiment mixing in step (303) is performed at a temperature ranging from 145° F. to 155° F. According to another preferred exemplary embodiment mixing in step (303) is performed at a temperature ranging from 148° F. to 152° F. According to a most exemplary embodiment mixing in step (303) is performed at a temperature of 150° F.

4. adding a solid binder forming a cold formable mixture (304); and

According to a preferred exemplary embodiment the solid binder in step (304) is added after the liquid binder is added in step (303). It is important the dates are added after the liquid binder is added as the addition of dates with the liquid binder or after the solid ingredients may not provide the required cohesiveness or sometimes cause smearing onto the resultant food bar. In order to avoid smearing and maintain the integrity of the solid ingredients, dates are added and may be gently mixed. According to a preferred exemplary embodiment the solid binder comprises diced dates, which may be cut into smaller pieces. In some embodiments the solid ingredients are selected from a group consisting of: prunes, plums, figs, raisins, apricots, and peaches. According to a preferred exemplary embodiment brittle ingredients are added along with the solid binder in step (304). According to a preferred exemplary embodiment the brittle ingredients are selected from a group consisting of: spinach, blueberries, kale, and combinations thereof.

5. forming the cold formable mixture into a food bar (305).

The method of forming the cold-formed bar may further comprise the steps of:
a) processing the cold-formable dough through feed rollers maintained at 120° F.;
b) compressing said cold-formable dough to make a dough slab with at least one compression roller;
c) processing the cold-formable dough through a cooling tunnel maintained at less than 50° F.;
d) cutting to form a plurality of food bars.

FIG. 4 is a perspective view of a resultant cold-formed food bar formed in accordance with one embodiment of the present invention. As shown in FIG. 4, the cold-formed food bar 400 comprises inclusions 401 and solid binder 402. According to a preferred exemplary embodiment, the rigidity, appearance and the texture of the food bar 400, is kept intact with the addition of the solid binder 402 while reducing the amount of added sugars in the food bar. The food bar 400 may be manufactured with the aforementioned process 300 and in the manufacturing system 200. According to a preferred exemplary embodiment, the food bar comprises at least 70% by weight of minimally processed inclusions 401; at least 20% by weight of a liquid binder; and at least 5% by weight of a solid binder 402. In the final cold-formed product, all individual ingredients retain the appearance and integrity. A liquid binder that is generally used contributes to the added sugars in the food bar 400. The solid binder in the form of dates reduce the amount of liquid binder required to bind the inclusions while providing the binding to the final cold-formed bar. According to a preferred exemplary embodiment the solid binder is diced dates. According to another preferred exemplary embodiment the solid binder is selected from a group consisting of: prunes, plums, figs, raisins, apricots, and peaches. According to yet another preferred exemplary embodiment the minimally processed ingredients are selected from a group consisting of: fruits, nuts, vegetables, and combinations thereof.

According to one exemplary embodiment the size of the minimally processed inclusions range from ⅛″-¾″. The inclusions may be whole or diced. For example, the inclusions may be whole almonds or cut almonds. According to a preferred exemplary embodiment the size of the dates range from 1/16″-¾″. According to a more preferred exemplary embodiment the size of the dates range from ¼″-½″. According to a most preferred exemplary embodiment the size of the dates is 3/16″. According to a preferred exemplary embodiment the added sugars is at most 3 grams per 100 grams of the food bar. It should be noted that for a typical food bar with a liquid binder the added sugars in the food bar is 4 grams per 100 grams of the food bar. Addition of a solid binder and reduction of the liquid binder may result in at least a 25% reduction in added sugars. In some instances, the reduction in added sugar may be more than 40%. According to a preferred exemplary embodiment the liquid binder further comprises brown rice, syrup, tapioca solids, liquid chicory root extract, glycerin, oil, and lecithin. According to yet another preferred exemplary embodiment the solid binder is added after liquid binder is added to the minimally processed ingredients during making of the food bar. The mouthfeel, binding capacity and texture may be determined with an expert panel. According to a preferred exemplary embodiment brittle ingredients such as kale, spinach, blueberries, and combinations thereof are added to the food bar. Table 2 shows the ingredients and composition of an exemplary cold-formed bar.

TABLE 2
Ingredients for an exemplary Cold-Formed Bar

| Ingredient | Formula wt. % |
|---|---|
| Dry Ingredients | 70-75 |
| Liquid Binder | 20-25 |
| Solid Binder | 5-7 |
| Total = | 100.0 |

While the invention has been particularly shown and described with reference to a preferred embodiment, it will be understood by those skilled in the art that various changes in form and detail may be made therein without departing from the spirit and scope of the invention. For example, the dimensions may be changed to increase or decrease the overall size of the cold formed bars; the shapes of the inclusions may be changed; and the solid ingredient composition may be varied to adjust the texture and flavor of the final product, and to accommodate various flavor combinations and/or inclusions. The overall intent of this invention is to create a cold-formed bar with a solid binder and reduce the amount of added sugars in the bar.

What is claimed is:

1. A method for making a food bar, said method comprising the steps of:
(a) setting a blender to a desired temperature;
(b) adding solid ingredients and mixing the solid ingredients;
(c) adding a liquid binder and mixing the liquid binder;
(d) adding a solid binder forming a cold formable mixture; and
(e) forming said cold formable mixture into a food bar.

2. The method of claim 1 wherein the desired temperature in step (a) is 125° F.

3. The method of claim 1 wherein the desired temperature in step (a) ranges from 100° F. to 125° F.

4. The method of claim 1 wherein the solid ingredients are selected from a group consisting of: grains, legumes, fruits, nuts, chocolate chips, vegetables, minimally processed inclusions and combinations thereof.

5. The method of claim 1 wherein mixing in step (b) is performed for a time ranging from 60 seconds to 80 seconds.

6. The method of claim 1 wherein mixing in step (c) is performed for a time ranging from 60 seconds to 90 seconds.

7. The method of claim 1 wherein mixing in step (c) is performed at a temperature ranging from 140° F. to 160° F.

8. The method of claim 1 wherein the solid binder in step (d) is added after the liquid binder is added in step (c).

9. The method of claim 1 wherein the solid binder comprises diced dates.

10. The method of claim 1 wherein brittle ingredients are added along with the solid binder in step (d).

11. The method of claim 10 wherein the brittle ingredients are selected from a group consisting of: spinach, blueberries, and combinations thereof.

12. The method of claim 1 wherein the forming at step (e) further comprises the steps of:
processing the cold formable dough through feed rollers maintained at 120° F.;
compressing said cold formable dough to make a dough slab with at least one compression roller;
processing the cold formable dough through a cooling tunnel maintained at less than 50° F.; and
cutting to form a plurality of food bars.

13. A cold-formed food bar comprising:
at least 70% by weight of minimally processed inclusions;
at least 20% by weight of a liquid binder;
and at least 5% by weight of a solid binder.

14. The food bar of claim 13 wherein the solid binder is diced dates.

15. The food bar of claim 13 wherein the solid binder is selected from a group consisting of: prunes, plums, figs, raisins, apricots, and peaches.

16. The food bar of claim 13 wherein the minimally processed ingredients are selected from a group consisting of: fruits, nuts, vegetables, and combinations thereof.

17. The food bar of claim 13 wherein the size of the minimally processed inclusions range from ⅛″-¾″.

18. The food bar of claim 13 wherein the size of the dates range from ⅛″-¾″.

19. The food bar of claim 13 wherein the added sugars is at most 3 grams per 100 g of the food bar.

20. The food bar of claim 13 wherein the liquid binder further comprises brown rice, syrup, tapioca solids, liquid chicory root extract, glycerin, oil, and lecithin.

21. The food bar of claim 13 wherein the solid binder is added after liquid binder is added to the minimally processed ingredients during making of the food bar.

22. The food bar of claim 13 wherein spinach, blueberries, kale, and combinations thereof are added to the food bar.
